(19) United States
(12) Patent Application Publication
(10) Pub. No.: US 2026/0290280 A1
(43) Pub. Date: Sep. 24, 2026

(54) POWER EFFICIENT DISPLAY COLOR PROCESSING FOR STATIC REGIONS ON SCREEN

(71) Applicant: QUALCOMM Incorporated, San Diego, CA (US)

(72) Inventors: Dileep MARCHYA, Hyderabad (IN); Padmanabhan KOMANDURU V, Hyderabad (IN); Anjaneya Prasad MUSUNURI, Hyderabad (IN); Srinivas PULLAKAVI, Kakinada (IN)

(21) Appl. No.: 19/474,677

(22) PCT Filed: May 24, 2024
(86) PCT No.: PCT/US2024/031145

§ 371 Date: Oct. 10, 2025

(30) Foreign Application Priority Data
May 26, 2023 (IN) 202341036492

(51) Int. Cl. G09G 5/02

(52) U.S. Cl. CPC G09G 5/02; G09G 2320/0242; G09G 2330/021; G09G 2340/16; G09G 2354/00; G09G 2360/18; G09G 2370/16

(57) ABSTRACT

This disclosure provides systems, devices, apparatus, and methods, including computer programs encoded on storage media, for power efficient display color processing for static regions on a screen. A processor may obtain a first indication that a first region of a first frame will remain static. The processor may aggregate, based on the first indication, a second region for each frame in a set of frames that is subsequent to the first frame, where each frame in the set of frames includes the first region that will remain static, and where the second region for each frame in the set of frames differs for each frame in the set of frames. The processor may output a second indication of the aggregated second region for each frame in the set of frames.

### CROSS REFERENCE TO RELATED APPLICATION(S)

This application claims the benefit of Indian Provisional Application No. 202341036492, entitled “POWER EFFICIENT DISPLAY COLOR PROCESSING FOR STATIC REGIONS ON SCREEN” and filed on May 26, 2023, which is expressly incorporated by reference herein in its entirety.

### TECHNICAL FIELD

The present disclosure relates generally to processing systems, and more particularly, to one or more techniques for display processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for display processing may result in redundant pixel processing and display processing. There is a need for improved techniques pertaining to pixel processing and display processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus includes a memory; and a processor coupled to the memory and, based on information stored in the memory, the processor is configured to: obtain a first indication that a first region of a first frame will remain static; aggregate, based on the first indication, a second region for each frame in a set of frames that is subsequent to the first frame, where each frame in the set of frames includes the first region that will remain static, and where the second region for each frame in the set of frames differs for each frame in the set of frames; and output a second indication of the aggregated second region for each frame in the set of frames.

In an aspect of the disclosure, a method, a computer-readable medium, and an apparatus are provided. The apparatus includes a memory; and a processor coupled to the memory and, based on information stored in the memory, the processor is configured to: obtain a first indication of an aggregated second region for each frame in a set of frames, where each frame in the set of frames includes a first region that will remain static, where the second region for each frame in the set of frames differs for each frame in the set of frames, and where the set of frames is subsequent to a first frame that includes the first region; blend, based on the first frame, the second region for each frame in the set of frames; and perform post-processing on the blended second region for each frame in the set of frames.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example display framework including a display processor and a display in accordance with one or more techniques of this disclosure.

FIG. 4 is a diagram illustrating example aspects of power efficient display color processing for static regions on a screen in accordance with one or more techniques of this disclosure.

FIG. 5 is a diagram illustrating an example of power efficient display color processing for static regions on a screen in accordance with one or more techniques of this disclosure.

FIG. 6 is a diagram illustrating an example of power efficient display color processing for static regions on a screen in accordance with one or more techniques of this disclosure.

FIG. 7 is a call flow diagram illustrating example communications between a central processing unit (CPU) and a display processor in accordance with one or more techniques of this disclosure.

FIG. 8 is a flowchart of an example method of display processing in accordance with one or more techniques of this disclosure.

FIG. 9 is a flowchart of an example method of display processing in accordance with one or more techniques of this disclosure.

FIG. 10 is a flowchart of an example method of display processing in accordance with one or more techniques of this disclosure.

FIG. 11 is a flowchart of an example method of display processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit. The term “frame” may refer to a frame or an image utilized in display processing. The term “depth frame” may refer to a frame that includes information pertaining to a distance at which an object in a frame is to be rendered with respect to a position of a user. The term “wearable display device” may refer to a device that is capable of being worn by a user to display content (e.g., a head device, a head mounted display (HMD), glasses, etc.). The term “workload” may refer to a workload that is processed at a graphics processor or a GPU (e.g., a vertex or pixel workload). The term “field of view” or “FOV” may refer to a range of an observable world that is visible at any given time through a human eye, through a camera viewfinder, or on a display screen. The term “static” may refer to lacking in movement, unchanging, or still. The term “aggregate” may refer to combining, assembling, or grouping into a cluster or a class. The terms “post-processing” may include adjusting a brightness of pixels, tone mapping pixels, gamma correcting pixels, and/or performing picture adjusting with respect to pixels. Post-processing a frame may include composing the frame to generate the post-processed frame. The term “usage pattern” may refer to a pattern of usage, e.g., for an application. The term “blend” may refer to blending, combining, or mixing pixels in frames for display processing.

A display processor (e.g., a display processing unit (DPU)) may transfer an entire frame buffer to a display panel (e.g., a display panel operating in video mode) regardless of a temporal change in a scene being displayed, that is, the display processor may transfer both static regions and non-static regions for each frame to the display panel. However, some pixels may remain static from frame to frame. A display pipeline (e.g., a display pipeline of a smartphone or a tablet) may be configured in a fixed configuration. For instance, display processing blocks may be configured once and the display processing blocks may be used in the same manner on each refresh occurrence. This may lead to redundant pixel processing (i.e., pixel processing repeated on regions of frames which do not change on a frame-by-frame basis). Redundant pixel processing may be associated with an inefficient use of computing resources.

Various technologies pertaining to power efficient display color processing for static regions on a screen are described herein. In an example, an apparatus (e.g., a CPU executing display driver software or DPU driver software) obtains a first indication that a first region of a first frame will remain static. The apparatus (e.g., a CPU executing display driver software or DPU driver software) aggregates, based on the first indication, a second region for each frame in a set of frames that is subsequent to the first frame, where each frame in the set of frames includes the first region that will remain static, and where the second region for each frame in the set of frames differs for each frame in the set of frames. Aggregating may refer to marking the second region as being an updating region in a frame with respect to the first frame so as to facilitate blending (e.g., delta blending) of the second region of the frame with respect to the first frame. The apparatus (e.g., a CPU executing display driver software or DPU driver software) outputs a second indication of the aggregated second region for each frame in the set of frames. In another example, an apparatus (e.g., a display processor) obtains a first indication of an aggregated second region for each frame in a set of frames, where each frame in the set of frames includes a first region that will remain static, where the second region for each frame in the set of frames differs for each frame in the set of frames, and where the set of frames is subsequent to a first frame that includes the first region. The apparatus (e.g., a display processor) blends, based on the first frame, the second region for each frame in the set of frames. The apparatus (e.g., a display processor) performs post-processing on the blended second region for each frame in the set of frames. Vis-à-vis the above-described technologies, redundant pixel processing on static regions of frames may be reduced or eliminated, which may lead to reduced use of computational resources and/or reduced power usage at a device, such as a smartphone.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

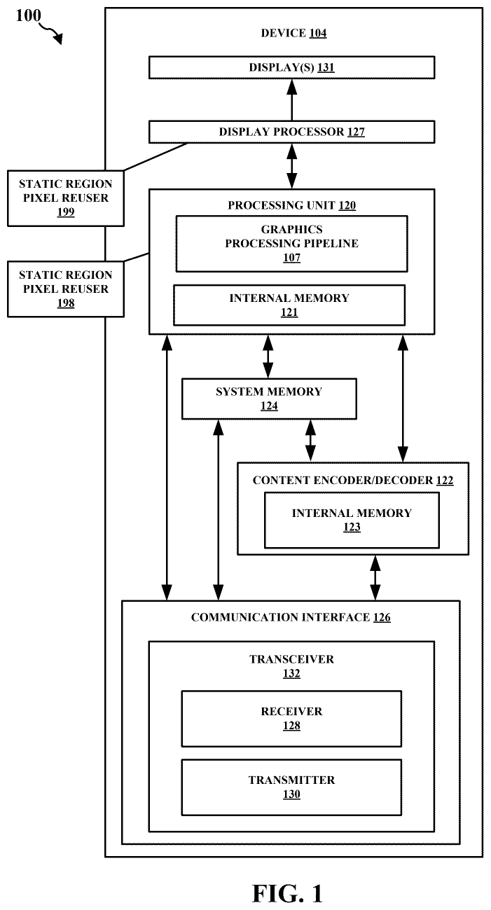

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a static region pixel reuser 198 configured obtain a first indication that a first region of a first frame will remain static; aggregate, based on the first indication, second region for each frame in a set of frames that is subsequent to the first frame, where each frame in the set of frames includes the first region that will remain static, and where the second region for each frame in the set of frames differs for each frame in the set of frames; and output a second indication of the aggregated second region for each frame in the set of frames. In certain aspects, the display processor 127 may include a static region pixel reuser 199 configured to obtain a first indication of an aggregated second region for each frame in a set of frames, where each frame in the set of frames includes a first region that will remain static, where the second region for each frame in the set of frames differs for each frame in the set of frames, and where the set of frames is subsequent to a first frame that includes the first region; blend, based on the first frame, the second region for each frame in the set of frames; and perform post-processing on the blended second region for each frame in the set of frames. Although the following description may be focused on display processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

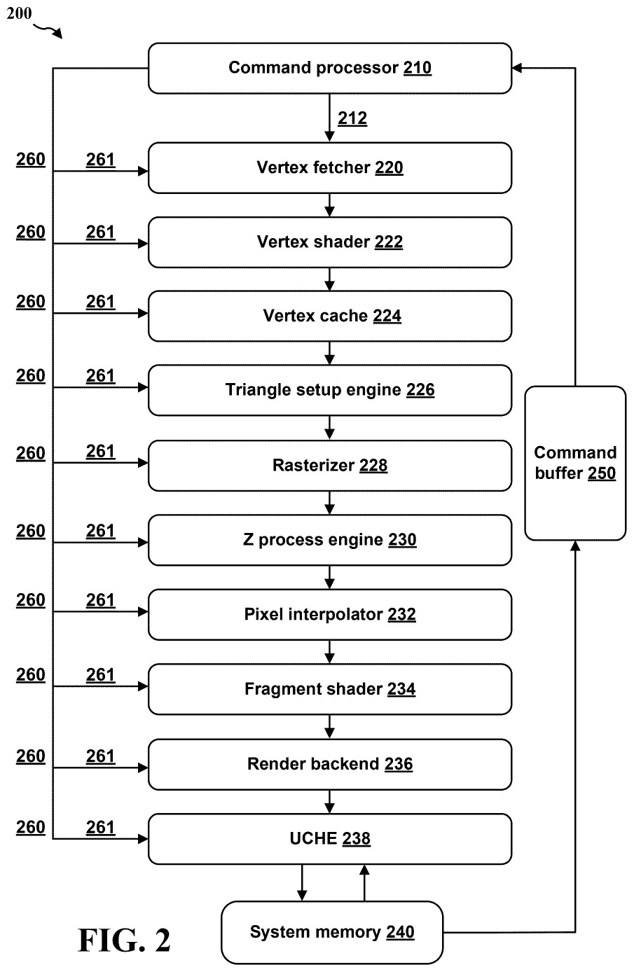

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

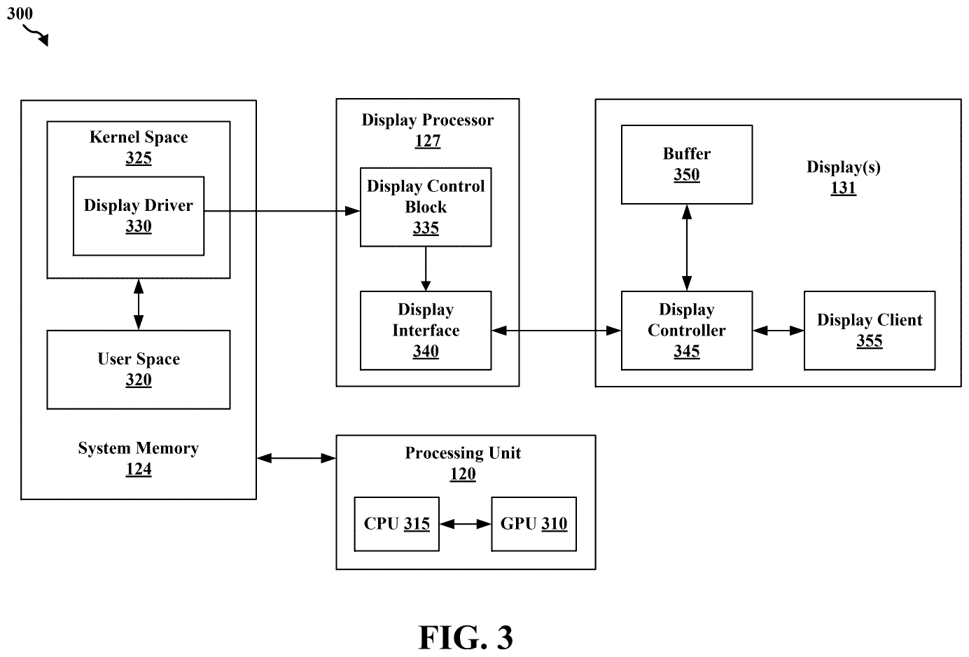

FIG. 3 is a block diagram 300 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 310 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 310 may be controlled based on one or more graphics processing commands provided by a CPU 315. The CPU 315 may be configured to execute multiple applications concurrently. In some cases, each of the concurrently executed multiple applications may utilize the GPU 310 simultaneously. Processing techniques may be performed via the processing unit 120 output a frame over physical or wireless communication channels.

The system memory 124, which may be executed by the processing unit 120, may include a user space 320 and a kernel space 325. The user space 320 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 325 may further include a display driver 330. The display driver 330 may be configured to control the display processor 127. For example, the display driver 330 may cause the display processor 127 to compose a frame and transmit the data for the frame to a display.

The display processor 127 includes a display control block 335 and a display interface 340. The display processor 127 may be configured to manipulate functions of the display(s) 131 (e.g., based on an input received from the display driver 330). The display control block 335 may be further configured to output image frames to the display(s) 131 via the display interface 340. In some examples, the display control block 335 may additionally or alternatively perform post-processing of image data provided based on execution of the system memory 124 by the processing unit 120.

The display interface 340 may be configured to cause the display(s) 131 to display image frames. The display interface 340 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 350.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 350. For example, when a Vsync pulse is generated, the display processor 127 may output new graphical content to the buffer 350. Thus, generation of the Vsync pulse may indicate that current graphical content has been rendered at the buffer 350.

Frames are displayed at the display(s) 131 based on a display controller 345, a display client 355, and the buffer 350. The display controller 345 may receive image data from the display interface 340 and store the received image data in the buffer 350. In some examples, the display controller 345 may output the image data stored in the buffer 350 to the display client 355. Thus, the buffer 350 may represent a local memory to the display(s) 131. In some examples, the display controller 345 may output the image data received from the display interface 340 directly to the display client 355.

The display client 355 may be associated with a touch panel that senses interactions between a user and the display(s) 131. As the user interacts with the display(s) 131, one or more sensors in the touch panel may output signals to the display controller 345 that indicate which of the one or more sensors have sensor activity, a duration of the sensor activity, an applied pressure to the one or more sensor, etc. The display controller 345 may use the sensor outputs to determine a manner in which the user has interacted with the display(s) 131. The display(s) 131 may be further associated with/include other devices, such as a camera, a microphone, and/or a speaker, that operate in connection with the display client 355.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 310 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

Certain display panels (e.g., low-temperature polycrystalline oxide (LTPO) panels, adaptive refresh panels (ARPs), etc.) may be configured (e.g., via a video model panel configuration) to support relatively high refresh rates. In the case of video model panels, a DPU may transfer an entire frame buffer to a panel at a display refresh rate regardless of a temporal change in a scene, that is, the DPU may transfer static regions and non-static regions for each frame. For instance, static regions may be transferred and composed repeatedly, which may lead to an inefficient use of computing resources. In one example (i.e., full static), an application (e.g., a text messaging application, a portable document format (PDF) application, a web browser, etc.) may have frequent intermittent screen idling in between scrolling. The application may transfer a frame buffer for each frame, even when the application is not being scrolled through by a user. In another example (i.e., partial static), a video playing application may include a video player region (non-static) and a non-video player region (static). The DPU may transfer a frame buffer for both the video player region and the non-video player region at each frame.

A display pipeline (e.g., a display pipeline of a smartphone or a tablet) may be configured in a fixed configuration. For instance, display processing blocks may be configured once and the display processing blocks may be used in the same manner on each refresh occurrence. This may lead to redundant pixel processing (i.e., pixel processing repeated on static regions of a frame). Redundant pixel processing may be associated with an inefficient use of computing resources. Various technologies described herein may relate to optimizing power consumption by reducing redundant pixel processing in display hardware blocks.

For video mode panels, a DPU may transfer an entire frame buffer (i.e., FrameBuffer) to a panel at a display refresh rate regardless of the temporal change in a scene. Thus, even static regions may need to be transferred every frame. This may result in redundant pixel processing. Aspects presented herein may utilize a prediction model to determine likely static regions and generate concurrent writeback cache hints. Based on the cache hint, a concurrent writeback (CWB) may be performed to cache post-processed pixels (e.g., cache post-processed pixels in a DDR one time). The CWB buffer may be used to drive subsequent frame updates by blending updating regions on top of the CWB buffer and limiting post-processing to the updating regions.

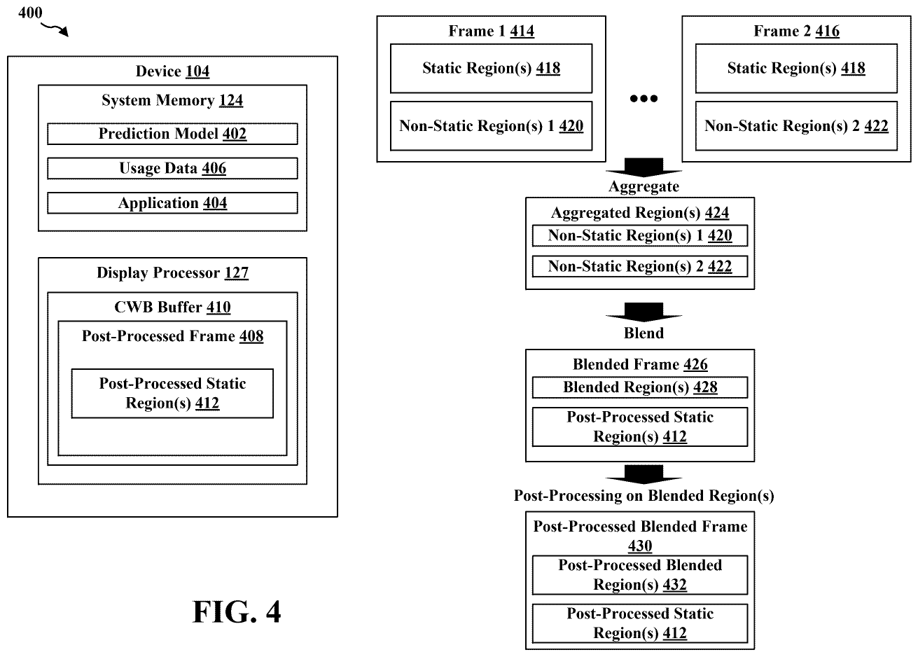

FIG. 4 is a diagram 400 illustrating example aspects of power efficient display color processing for static regions on a screen in accordance with one or more techniques of this disclosure. The system memory 124 of the device 104 may include a prediction model 402. The prediction model 402 may be configured to (1) determine likely static regions (i.e., predict static regions) for frames of an application 404 executed by the device 104 and (2) generate concurrent writeback (CWB) cache hints (i.e., an indication that a region of a frame will remain static) based on the determined likely static regions. Based on the cache hint, CWB may be performed to cache post-processed pixels in memory (e.g., double date rate (DDR) memory) once. The CWB may be used to drive subsequent frame updates by (1) blending updating regions on top of a CWB buffer and (2) limiting post-processing to the updating regions.

In an example, the device 104 (or another device) may learn a pattern associated with the application 404. The device may predict a future reusability of CWB pixels. The device 104, via the prediction model 402, may generate cache hints (which may also be referred to as CWB cache hints). The device 104 may configure display hardware (e.g., the display processor 127) to capture a post-processed frame through a CWB (i.e., store the post-processed frame in a CWB cache or a CWB buffer) upon receiving a cache hint. As use herein CWB may refer to concurrently (1) processing pixels of a frame and (2) storing the frame (or another frame) in a buffer, a cache, or a memory. On subsequent refresh instances, the device 104 (e.g., via the processing unit 120) may aggregate updating regions frame-on-frame with respect to the captured post-processed frame. The device 104 (e.g., via the processing unit 120) may configure the display hardware (e.g., the display processor 127) to perform delta blending in the aggregated updating regions on top of the stored post-processed frame. The device 104 (e.g., via the processing unit 120) may configure the display hardware (e.g., the display processor 127) to limit post-processing to the aggregated regions. The device 104 may wait for a next cache hint once the aggregated regions become equal or nearly equal to the stored post-processed frame (i.e., once the aggregated regions become equal or nearly equal to a CWB buffer).

In an example, the application 404 may be a messaging application (e.g., a text messaging application), a web browser, a document viewer (e.g., a PDF viewer), or a video player application (e.g., a streaming video player). Learning an application pattern for the application 404 may include generating (e.g., training) the prediction model 402. The prediction model 402 may include learned parameters (e.g., weights), where values of the learned parameters may be based upon usage data 406 of the application 404 for a user of the application 404 or users of the application 404. In an example, the prediction model 402 may be a neural network. In one aspect, the prediction model 402 may be generated and/or updated at the device 104. In another example, a computing device (not shown in FIG. 4) may generate the prediction model 402 based on usage data of the application for users and the computing device may provide (e.g., transmit) the prediction model 402 to the device 104, whereupon the device 104 may update the prediction model 402 based on usage data of the user of the application 404. The prediction model 402 may be alternatively referred to as a machine learning model or a lightweight prediction model.

In an example, the application 404 may be executed by the device 104. As the application 404 executes, the device 104 may receive user input (e.g., typing on an onscreen keyboard on a touchscreen) with respect to the application 404. Display driver software (e.g., display driver software executed by a CPU) may provide, as input to the prediction model 402, data indicative of the user input. The prediction model 402 may output, based on the user input and the learned parameters, an indication (i.e., a cache hint) of region(s) of a frame of the application 404 that are predicted to remain static (e.g., predicted to remain static for a time duration). In one aspect, the display driver software may be configured to generate cache hints via the prediction model 402 at a particular frequency (e.g., one time per second, ten times per second, etc.). In one aspect, the cache hint may remain valid for a duration of time (e.g., one second, five seconds, etc.). In one aspect, the display driver software may provide additional data (e.g., data indicative of a state of the application 404) as input to the prediction model 402 and the prediction model 402 may output the indication of the region(s) of the frame of the application 404 that are predicted to remain static further based on the additional data.

The display driver software may configure the display processor 127 to capture a post-processed frame through a CWB based on the cache hint. In an example, the display driver software may transmit the cache hint for a frame to the display processor 127. The display processor 127 may also obtain a frame (e.g., from a CPU, from a GPU, etc.). Upon receiving the cache hint, the display processor 127 may perform a CWB in order to store a post-processed frame 408 in a CWB buffer 410 associated with the display processor 127, where the post-processed frame includes post-processed static region(s) 412 indicated by the cache hint. With more particularity, upon receiving the cache hint, the display processor 127 may perform post-processing on the frame to generate the post-processed frame 408 and the display processor 127 may write the post-processed frame 408 to the CWB buffer 410. Post-processing may include adjusting brightness of pixels, tone mapping the pixels, gamma correcting the pixels, and/or performing picture adjusting with respect to the pixels. In an example, post-processing the frame may also include composing the frame to generate the post-processed frame 408. The CWB buffer 410 may be alternatively referred to as a CWB cache, a cache, a buffer, or memory. Although the CWB buffer 410 is depicted in FIG. 4 as being part of the display processor 127, in some examples, the CWB buffer 410 may be separate from the display processor 127.

At a next refresh instance occurring subsequent to the post-processed frame 408 being stored in the CWB buffer 410, the display processor 127 may aggregate updating regions frame-on-frame with respect to the post-processed frame 408 stored in the CWB buffer 410. For example, the application 404 may generate (i.e., render) a first frame 414 and a second frame 416. The first frame 414 may include static region(s) 418, where the static region(s) 418 are not post-processed and where the static region(s) 418 may correspond to the post-processed static region(s) 412 of the post-processed frame 408, that is, the static region(s) 418 may be region(s) of the first frame 414 that do not change with respect to the post-processed frame 408. The first frame 414 may also include first non-static region(s) 420, where the first non-static region(s) 420 are not likely to remain static, that is, the first non-static region(s) 420 may correspond to areas of a screen that are to be updated in comparison to the post-processed frame 408. The second frame 416 may include the static region(s) 418, where the static region(s) 418 are not post-processed and where the static region(s) 418 may correspond to the post-processed static region(s) 412 of the post-processed frame 408, that is, the static region(s) 418 may be region(s) of the second frame 416 that do not change with respect to the post-processed frame 408. The second frame 416 may also include second non-static region(s) 422, where the second non-static region(s) 422 are not likely to remain static, that is, the second non-static region(s) 422 may correspond to areas of a screen that are to be updated in comparison to the post-processed frame 408. In an example, the first frame 414 may correspond to a first layer of displayed content and the second frame 416 may correspond to a second layer of the displayed content. Aggregating the first non-static region(s) 420 and the second non-static region(s) 422 may produce aggregated region(s) 424 that include the first non-static region(s) 420 and the second non-static region(s) 422. The display driver software may transmit the aggregated region(s) 424 (or an indication thereof) to the display processor 127.

The display processor 127 may blend the aggregated region(s) 424 based on the post-processed frame 408 to generate a blended frame 426, where the blended frame 426 may include blended region(s) 428 and the post-processed static region(s) 412. In an example, blending the aggregated region(s) 424 may include delta blending the aggregated region(s) 424.

The display processor 127 may perform post-processing on the blended region(s) 428 to generate a post-processed blended frame 430, where the post-processed blended frame 430 includes post-processed blended region(s) 432 and the post-processed static region(s) 412. The display processor 127 may not perform additional post-processing on the post-processed static region(s) 412, as pixels of the post-processed static region(s) 412 were post-processed prior to or concurrently with the post-processed frame 408 being stored in the CWB buffer 410. Thus, the display processor 127 may avoid performing redundant post-processing. The display processor 127 may output the post-processed blended frame 430 for display on a display panel (e.g., the display(s) 131, an ARP panel, a LTPO panel, etc.).

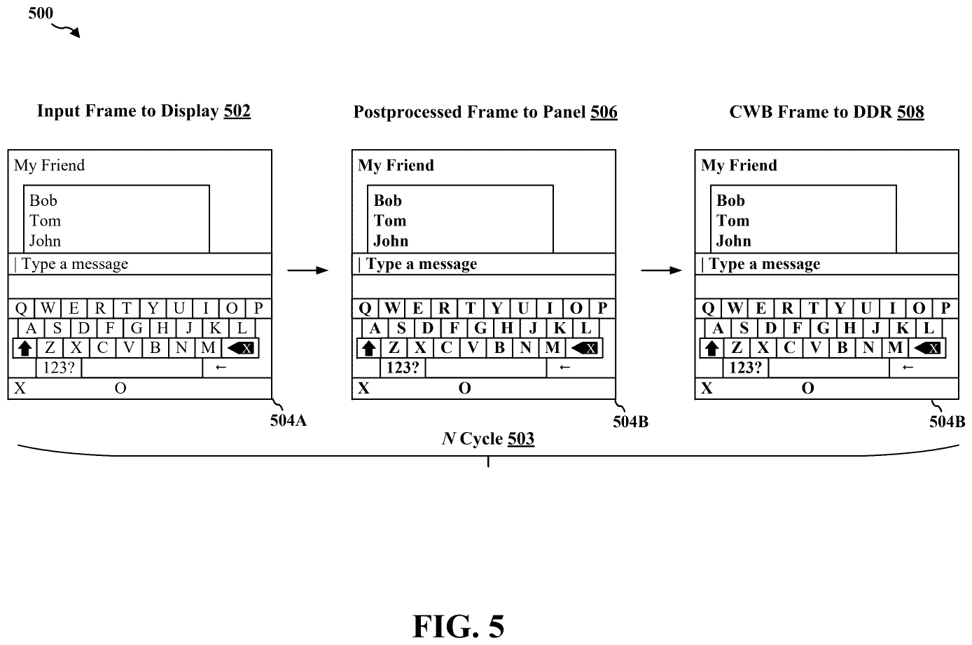

FIG. 5 is a diagram 500 illustrating an example of power efficient display color processing for static regions on a screen in accordance with one or more techniques of this disclosure. At 502, and during an Nth cycle 503 (N is an integer), a device (e.g., the device 104) may render a frame 504A of a messaging application (e.g., the application 404). At 506, the device (via display hardware) may perform post-processing on the frame 504A to generate a post-processed frame 504B and the device may output the post-processed frame 504B for display on a display panel (e.g., the display(s) 131). In an example, performing the post-processing on the frame 504A may include brightening the frame 504A from a first brightness level to a second brightness level, where the second brightness level is greater than the first brightness level.

Display driver software of the device may generate a cache hint as described above in the description of FIG. 4. The display driver software may transmit the cache hint to display hardware (e.g., the display processor 127). Upon receiving the cache hint, at 508, the display hardware may perform a CWB to write the post-processed frame 504B to a cache, a memory, or a buffer. In an example, the display hardware may cache the post-processed frame 504B in the CWB buffer 410.

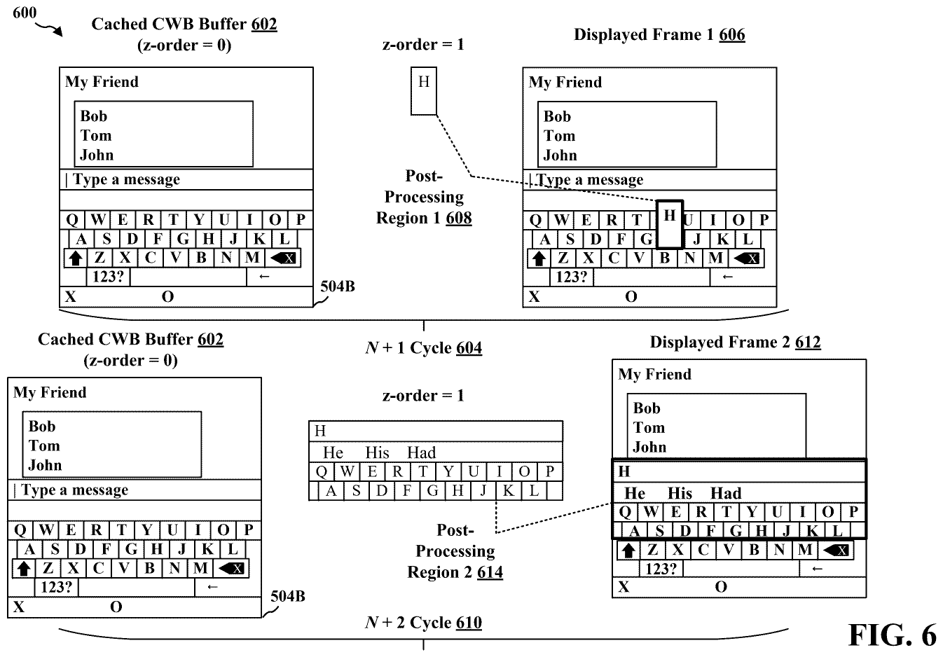

FIG. 6 is a diagram 600 illustrating an example of power efficient display color processing for static regions on a screen in accordance with one or more techniques of this disclosure. The example described below continues from the example described above with respect to FIG. 5.

As noted above, display hardware may store the post-processed frame 504B in a cache, a memory, or a buffer upon receiving the cache hint. For instance, the display hardware may cache the post-processed frame 504B in a cached CWB buffer 602 during the Nth cycle 503. The post-processed frame 504B may have a z-order equal to zero, that is, the post-processed frame 504B may appear as a background frame.

In an N+1 cycle 604 occurring after the Nth cycle 503, the post-processed frame 504B may remain stored in the cached CWB buffer 602. During the N+1 cycle 604, the device may receive user input corresponding to the user touching an “H” letter displayed by the messaging application. The messaging application may generate a first frame 606 (referred to in FIG. 6 as “Displayed Frame 1”) based on the user input. As illustrated in FIG. 6, the first frame 606 may be similar to the post-processed frame 504B stored in the cached CWB buffer 602. In an example, the difference between the first frame 606 and the post-processed frame 504B may be that the first frame 606 includes a box including the letter “H” superimposed on a keyboard layout. The box including the letter “H” may correspond to a z-order of 1. Similar to the description of FIG. 4, display hardware (e.g., the display processor 127) may blend a region (i.e., a first post-processing region 608) corresponding to the box with the letter “H” based on the post-processed frame 504B. The display hardware may perform post-processing on the first post-processing region 608 without performing additional post-processing on the remainder of the first frame 606. Thus, the display hardware may avoid performing redundant post-processing on regions of the first frame 606 that have not changed with respect to the post-processed frame 504B.

In an N+2 cycle 610 occurring after the N+1 cycle 604, the post-processed frame 504B may remain stored in the cached CWB buffer 602. During the N+2 cycle 610, the device may receive an indication that the user has stopped touching the letter “H” displayed by the messaging application. The messaging application may generate a second frame 612 (referred to in FIG. 6 as “Displayed Frame 2”) based on the indication. As illustrated in FIG. 6, the second frame 612 may be similar to the post-processed frame 504B stored in the cached CWB buffer 602. In an example, the difference between the second frame 612 and the post-processed frame 504B may be (1) the second frame 612 includes an “H” in a message line and (2) the second frame 612 includes word suggestions (e.g., “He,” “His,” “Had,” etc.) below the message line. The difference may have a z-order of one. Similar to the description of FIG. 4, display hardware (e.g., the display processor 127) may blend a region (i.e., a second post-processing region 614) corresponding to the difference based on the post-processed frame 504B. The display hardware may perform post-processing on the second post-processing region 614 without performing additional post-processing on the remainder of the second frame 612. Thus, the display hardware may avoid performing redundant post-processing on regions of the second frame 612 that have not changed with respect to the post-processed frame 504B.

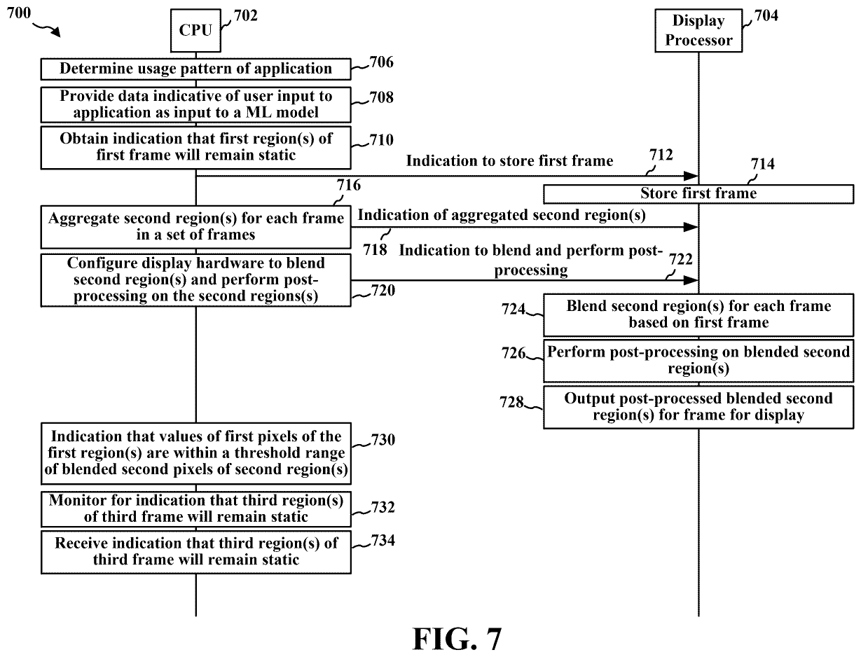

FIG. 7 is a call flow diagram 700 illustrating example communications between a CPU 702 and a display processor 704 in accordance with one or more techniques of this disclosure. In an example, the CPU 702 and the display processor 704 may be included in the device 104. In an example, the display processor 704 may be or include the display processor 127.

At 706, the CPU 702 may determine a usage pattern of an application associated with the first frame based on usage data for the application. Determining the usage pattern may include training or updating a machine learning model based on the usage data, where the machine learning model includes a set of learned parameters that are based on the usage data. At 708, the CPU 702 may provide, as input to the machine learning model, data indicative of user input with respective to the application, where obtaining the first indication includes obtaining the first indication as output from the machine learning model. At 710, the CPU 702 may obtain a first indication that a first region of a first frame will remain static. At 712, the CPU 702 may transmit, based on the first indication, an indication to store the first frame, where the first frame is post-processed. At 714, the display processor 704 may store the first frame.

At 716, the CPU 702 may aggregate, based on the first indication, a second region for each frame in a set of frames that is subsequent to the first frame, where each frame in the set of frames includes the first region that will remain static, and where the second region for each frame in the set of frames differs for each frame in the set of frames. At 718, the display processor 704 may obtain a first indication of an aggregated second region for each frame in a set of frames, where each frame in the set of frames includes a first region that will remain static, where the second region for each frame in the set of frames differs for each frame in the set of frames, and where the set of frames is subsequent to a first frame that includes the first region. At 720, the CPU 702 may configure display hardware (i.e., the display processor 704) to (1) blend the second region for each frame in the set of frames and (2) perform post-processing on the second region for each frame in the set of frames. For instance, at 722, the CPU 702 may transmit in indication to the display hardware (i.e., the display processor 704) to (1) blend the second region for each frame in the set of frames and (2) perform the post-processing on the second region for each frame in the set of frames.

At 724, the display processor 704 may blend, based on the first frame, the second region for each frame in the set of frames. At 726, the display processor 704 may perform post-processing on the blended second region for each frame in the set of frames. At 728, the display processor 704 may output the post-processed blended second region for each frame in the set of frames for display on a display panel.

At 730, the CPU 702 may obtain a third indication that values of first pixels of the first region of the first frame are within a threshold range of blended second pixels of the second region for each frame in the set of frames. At 732, the CPU 702 may monitor, based on the third indication, for a fourth indication that a third region of a third frame will remain static, where the third frame is subsequent to the first frame and the set of frames. At 734, the CPU 702 may receive, subsequent to the monitoring, the fourth indication that the third region of the third frame will remain static.

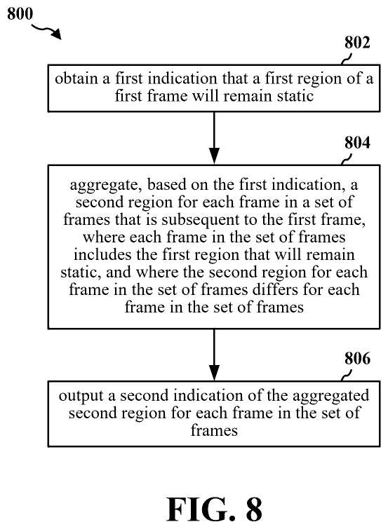

FIG. 8 is a flowchart 800 of an example method of display processing in accordance with one or more techniques of this disclosure. The method may be performed by an apparatus, such as an apparatus for display processing, a CPU, display driver software, a display processing unit (DPU) or other display processor, a wireless communication device, and the like, as used in connection with the aspects of FIGS. 1-7. In an example, the method may be performed by the static region pixel reuser 198.

At 802, the apparatus (e.g., a CPU) obtains a first indication that a first region of a first frame will remain static. For example, FIG. 7 at 710 shows that the CPU 702 may obtain a first indication (i.e., a cache hint) that a first region of a first frame will remain static. In an example, the first frame may be or include the post-processed frame 408 and the first region may be or include the post-processed static region(s) 412. In an example, the first frame may correspond to the screen of the messaging application at 506 in FIG. 5. In an example, 802 may be performed by the static region pixel reuser 198.

At 804, the apparatus (e.g., a CPU) aggregates, based on the first indication, a second region for each frame in a set of frames that is subsequent to the first frame, where each frame in the set of frames includes the first region that will remain static, and where the second region for each frame in the set of frames differs for each frame in the set of frames. For example, FIG. 7 at 716 shows that the CPU 702 may aggregate, based on the first indication, a second region for each frame in a set of frames that is subsequent to the first frame, where each frame in the set of frames includes the first region that will remain static, and where the second region for each frame in the set of frames differs for each frame in the set of frames. In an example, the set of frames may include the first frame 414 and/or the second frame 416. In another example, the first region of the set of frames may include the static region(s) 418 and the second region may include the first non-static region(s) 420 and/or second non-static region(s) 422. Furthermore, FIG. 4 shows that that the first non-static region(s) 420 and the second non-static region(s) 422 may be aggregated. In another example, the set of frames may correspond to the first frame 606 and the second frame 612. In a further example, the second region may correspond to the first post-processing region 608 and/or the second post-processing region 614. In an example, 804 may be performed by the static region pixel reuser 198.

At 806, the apparatus (e.g., a CPU) outputs a second indication of the aggregated second region for each frame in the set of frames. For example, FIG. 7 at 718 shows that the CPU 702 may output a second indication of the aggregated second region for each frame in the set of frames. In an example, 806 may be performed by the static region pixel reuser 198.

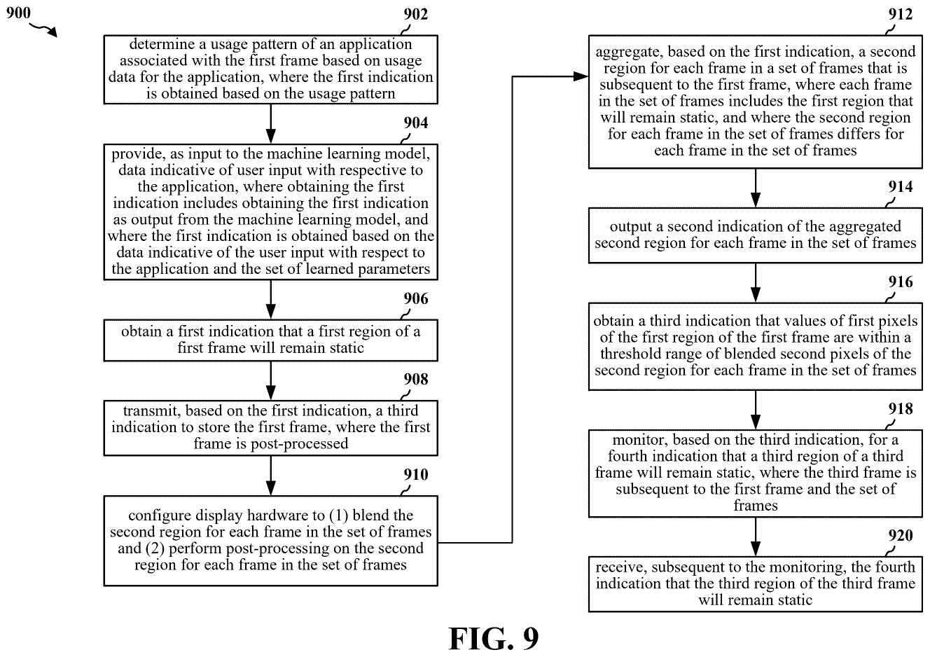

FIG. 9 is a flowchart 900 of an example method of display processing in accordance with one or more techniques of this disclosure. The method may be performed by an apparatus, such as an apparatus for display processing, a CPU, display driver software, a display processing unit (DPU) or other display processor, a wireless communication device, and the like, as used in connection with the aspects of FIGS. 1-7. In an example, the method (including the various aspects detailed below) may be performed by the static region pixel reuser 198.

At 906, the apparatus (e.g., a CPU) obtains a first indication that a first region of a first frame will remain static. For example, FIG. 7 at 710 shows that the CPU 702 may obtain a first indication (i.e., a cache hint) that a first region of a first frame will remain static. In an example, the first frame may be or include the post-processed frame 408 and the first region may be or include the post-processed static region(s) 412. In an example, the first frame may correspond to the screen of the messaging application at 506 in FIG. 5. In an example, 906 may be performed by the static region pixel reuser 198.

At 912, the apparatus (e.g., a CPU) aggregates, based on the first indication, a second region for each frame in a set of frames that is subsequent to the first frame, where each frame in the set of frames includes the first region that will remain static, and where the second region for each frame in the set of frames differs for each frame in the set of frames. For example, FIG. 7 at 716 shows that the CPU 702 may aggregate, based on the first indication, a second region for each frame in a set of frames that is subsequent to the first frame, where each frame in the set of frames includes the first region that will remain static, and where the second region for each frame in the set of frames differs for each frame in the set of frames. In an example, the set of frames may include the first frame 414 and/or the second frame 416. In another example, the first region of the set of frames may include the static region(s) 418 and the second region may include the first non-static region(s) 420 and/or second non-static region(s) 422. Furthermore, FIG. 4 shows that that the first non-static region(s) 420 and the second non-static region(s) 422 may be aggregated. In another example, the set of frames may correspond to the first frame 606 and the second frame 612. In a further example, the second region may correspond to the first post-processing region 608 and/or the second post-processing region 614. In an example, 912 may be performed by the static region pixel reuser 198.

At 914, the apparatus (e.g., a CPU) outputs a second indication of the aggregated second region for each frame in the set of frames. For example, FIG. 7 at 718 shows that the CPU 702 may output a second indication of the aggregated second region for each frame in the set of frames. In an example, 914 may be performed by the static region pixel reuser 198.

In one aspect, at 908, the apparatus (e.g., a CPU) may transmit, based on the first indication, a third indication to store the first frame, where the first frame is post-processed. For example, FIG. 7 at 712 shows that the CPU 702 may transmit, based on the first indication, a third indication to store the first frame, where the first frame is post-processed. The aforementioned aspect may correspond to 508 in FIG. 5. In an example, 908 may be performed by the static region pixel reuser 198.

In one aspect, at 902, the apparatus (e.g., a CPU) may determine a usage pattern of an application associated with the first frame based on usage data for the application, where the first indication may be obtained based on the usage pattern. For example, FIG. 7 at 706 shows that the CPU 702 may determine a usage pattern of an application associated with the first frame based on usage data for the application, where the first indication may be obtained based on the usage pattern. In an example, the application may be the application 404 and the usage data may be the usage data 406. In another example, the application may be the messaging application depicted in FIGS. 5 and 6. In an example, 902 may be performed by the static region pixel reuser 198.

In one aspect, determining the usage pattern may include training or updating a machine learning model based on the usage data, where the machine learning model may include a set of learned parameters that are based on the usage data. For example, determining the usage pattern of the application at 706 may include training or updating a machine learning model based on the usage data, where the machine learning model may include a set of learned parameters that are based on the usage data. In an example, the machine learning model may be or include the prediction model 402.

In one aspect, at 904, the apparatus (e.g., a CPU) may provide, as input to the machine learning model, data indicative of user input with respective to the application, where obtaining the first indication may include obtaining the first indication as output from the machine learning model, and where the first indication may be obtained based on the data indicative of the user input with respect to the application and the set of learned parameters. For example, FIG. 7 at 708 shows that the CPU 702 may provide, as input to the machine learning model, data indicative of user input with respective to the application, where obtaining the first indication may include obtaining the first indication as output from the machine learning model, and where the first indication may be obtained based on the data indicative of the user input with respect to the application and the set of learned parameters. In an example, the user input may correspond to the letter “H” being pressed as depicted in FIG. 6. In an example, 904 may be performed by the static region pixel reuser 198.

In one aspect, outputting the second indication of the aggregated second region for each frame in the set of frames may include outputting the second indication of the aggregated second region for each frame in the set of frames to a display processing unit (DPU). For example, FIG. 7 shows that the CPU 702 may output the second indication of the aggregated second region for each frame in the set of frames to the display processor 704. In an example, the DPU may be the display processor 127.

In one aspect, at 916, the apparatus (e.g., a CPU) may obtain a third indication that values of first pixels of the first region of the first frame are within a threshold range of blended second pixels of the second region for each frame in the set of frames. For example, FIG. 7 at 730 shows that the CPU 702 may obtain a third indication that values of first pixels of the first region of the first frame are within a threshold range of blended second pixels of the second region for each frame in the set of frames. In an example, 916 may be performed by the static region pixel reuser 198.

In one aspect, at 918, the apparatus (e.g., a CPU) may monitor, based on the third indication, for a fourth indication that a third region of a third frame will remain static, where the third frame is subsequent to the first frame and the set of frames. For example, FIG. 7 at 732 shows that the CPU 702 may monitor, based on the third indication, for a fourth indication (i.e., a second cache hint) that a third region of a third frame will remain static, where the third frame is subsequent to the first frame and the set of frames. In an example, 918 may be performed by the static region pixel reuser 198.

In one aspect, at 920, the apparatus (e.g., a CPU) may receive, subsequent to the monitoring, the fourth indication that the third region of the third frame will remain static. For example, FIG. 7 at 734 shows that the CPU may receive, subsequent to the monitoring, the fourth indication (i.e., the second cache hint) that the third region of the third frame will remain static. In an example, 920 may be performed by the static region pixel reuser 198.

In one aspect, at 910, the apparatus (e.g., a CPU) may configure display hardware to (1) blend the second region for each frame in the set of frames and (2) perform post-processing on the second region for each frame in the set of frames. For example, FIG. 7 at 720 shows that the CPU 702 may configure display hardware to (1) blend the second region for each frame in the set of frames and (2) perform post-processing on the second region for each frame in the set of frames. In an example, the display hardware may be or include a display processor such as the display processor 704 and/or a DPU. In an example, 910 may be performed by the static region pixel reuser 198.

In one aspect, configuring the display hardware may include: transmitting, to the display hardware, a third indication to (1) blend the second region for each frame in the set of frames and (2) perform the post-processing on the second region for each frame in the set of frames. For example, FIG. 7 at 722 shows that the CPU 702 may transmit a third indication to (1) blend the second region for each frame in the set of frames and (2) perform the post-processing on the second region for each frame in the set of frames.

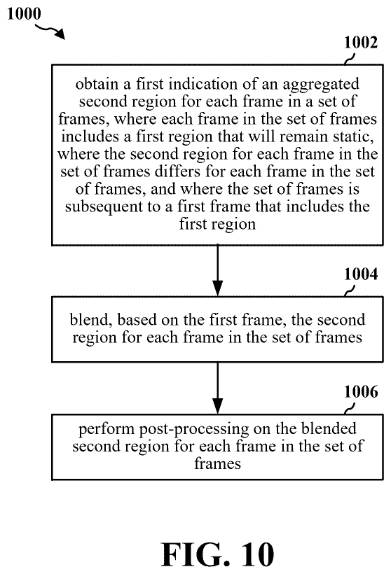

FIG. 10 is a flowchart 1000 of an example method of display processing in accordance with one or more techniques of this disclosure. The method may be performed by an apparatus, such as an apparatus for display processing, a display processing unit (DPU) or other display processor, a wireless communication device, and the like, as used in connection with the aspects of FIGS. 1-7. In an example, the method may be performed by the static region pixel reuser 199.

At 1002, the apparatus (e.g., a display processor) obtains a first indication of an aggregated second region for each frame in a set of frames, where each frame in the set of frames includes a first region that will remain static, where the second region for each frame in the set of frames differs for each frame in the set of frames, and where the set of frames is subsequent to a first frame that includes the first region. For example, FIG. 7 at 718 shows that the display processor 704 may obtain a first indication of an aggregated second region for each frame in a set of frames, where each frame in the set of frames includes a first region that will remain static, where the second region for each frame in the set of frames differs for each frame in the set of frames, and where the set of frames is subsequent to a first frame that includes the first region. In an example, the first frame may be or include the post-processed frame 408 and the first region may be or include the post-processed static region(s) 412. In an example, the first frame may correspond to the screen of the messaging application at 506 in FIG. 5. In an example, the set of frames may include the first frame 414 and/or the second frame 416. In another example, the first region of the set of frames may include the static region(s) 418 and the second region may include the first non-static region(s) 420 and/or second non-static region(s) 422. Furthermore, FIG. 4 shows that that the first non-static region(s) 420 and the second non-static region(s) 422 may be aggregated. In another example, the set of frames may correspond to the first frame 606 and the second frame 612. In a further example, the second region may correspond to the first post-processing region 608 and/or the second post-processing region 614. In an example, 1002 may be performed by the static region pixel reuser 199.

At 1004, the apparatus (e.g., a display processor) blends, based on the first frame, the second region for each frame in the set of frames. For example, FIG. 7 at 724 shows that the display processor 704 may blend, based on the first frame, the second region for each frame in the set of frames. In another example, FIG. 4 shows that the display processor 127 may blend the first non-static region(s) 420 and/or the second non-static region(s) 422. In an example, 1004 may be performed by the static region pixel reuser 199 At 1006, the apparatus (e.g., a display processor) performs post-processing on the blended second region for each frame in the set of frames. For example, FIG. 7 at 726 shows that the display processor 704 may perform post-processing on the blended second region for each frame in the set of frames. In another example, FIG. 4 shows that the display processor 127 may perform post-processing on the blended region(s) 428. In an example, 1006 may be performed by the static region pixel reuser 199.

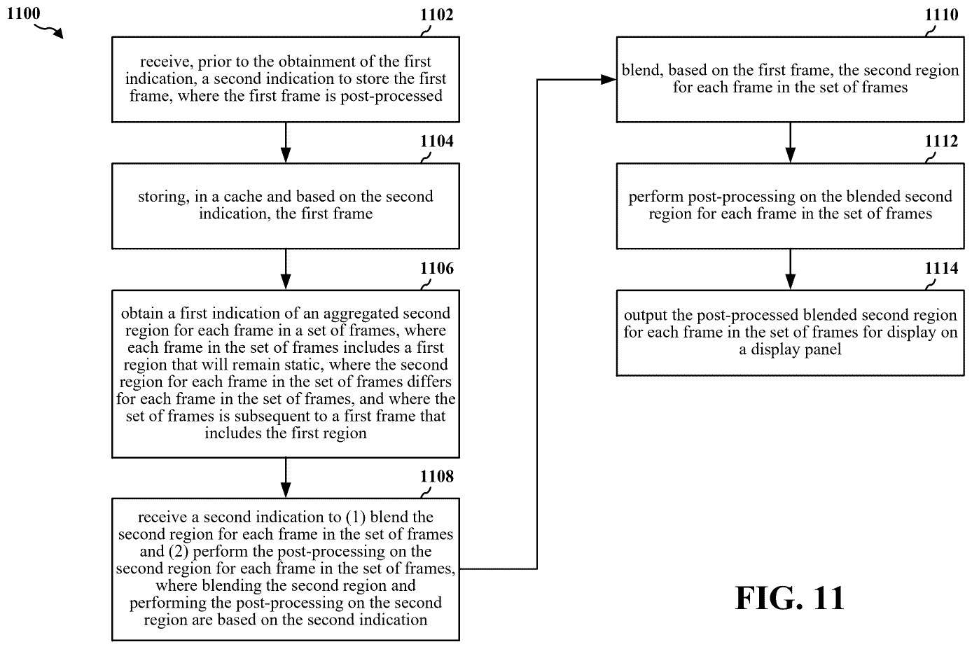

FIG. 11 is a flowchart 1100 of an example method of display processing in accordance with one or more techniques of this disclosure. The method may be performed by an apparatus, such as an apparatus for display processing, a display processing unit (DPU) or other display processor, a wireless communication device, and the like, as used in connection with the aspects of FIGS. 1-7. In an example, the method (including the various aspects detailed below) may be performed by the static region pixel reuser 199.

At 1106, the apparatus (e.g., a display processor) obtains a first indication of an aggregated second region for each frame in a set of frames, where each frame in the set of frames includes a first region that will remain static, where the second region for each frame in the set of frames differs for each frame in the set of frames, and where the set of frames is subsequent to a first frame that includes the first region. For example, FIG. 7 at 718 shows that the display processor 704 may obtain a first indication of an aggregated second region for each frame in a set of frames, where each frame in the set of frames includes a first region that will remain static, where the second region for each frame in the set of frames differs for each frame in the set of frames, and where the set of frames is subsequent to a first frame that includes the first region. In an example, the first frame may be or include the post-processed frame 408 and the first region may be or include the post-processed static region(s) 412. In an example, the first frame may correspond to the screen of the messaging application at 506 in FIG. 5. In an example, the set of frames may include the first frame 414 and/or the second frame 416. In another example, the first region of the set of frames may include the static region(s) 418 and the second region may include the first non-static region(s) 420 and/or second non-static region(s) 422. Furthermore, FIG. 4 shows that that the first non-static region(s) 420 and the second non-static region(s) 422 may be aggregated. In another example, the set of frames may correspond to the first frame 606 and the second frame 612. In a further example, the second region may correspond to the first post-processing region 608 and/or the second post-processing region 614. In an example, 1106 may be performed by the static region pixel reuser 199.

At 1110, the apparatus (e.g., a display processor) blends, based on the first frame, the second region for each frame in the set of frames. For example, FIG. 7 at 724 shows that the display processor 704 may blend, based on the first frame, the second region for each frame in the set of frames. In another example, FIG. 4 shows that the display processor 127 may blend the first non-static region(s) 420 and/or the second non-static region(s) 422. In an example, 1110 may be performed by the static region pixel reuser 199.

At 1112, the apparatus (e.g., a display processor) performs post-processing on the blended second region for each frame in the set of frames. For example, FIG. 7 at 726 shows that the display processor 704 may perform post-processing on the blended second region for each frame in the set of frames. In another example, FIG. 4 shows that the display processor 127 may perform post-processing on the blended region(s) 428. In an example, 1112 may be performed by the static region pixel reuser 199.

In one aspect, the post-processing may not be performed on the first region. In an example, FIG. 6 shows that post-processing may be performed on the first post-processing region 608 of the first frame 606 and not the remaining portions of the first frame 606. Stated differently, the remaining portions of the first frame 606 may be static regions corresponding to the cached CWB buffer 602 that have been previously post-processed (e.g., at 506), and as a result, redundant post-processing may not be performed on the remaining portions.

In one aspect, at 1102, the apparatus (e.g., a display processor) may receive, prior to the obtainment of the first indication, a second indication to store the first frame, where the first frame is post-processed. For example, FIG. 7 at 712 shows that the display processor 704 may receive, prior to the obtainment of the first indication, a second indication to store the first frame, where the first frame is post-processed. In an example, 1102 may be performed by the static region pixel reuser 199.

In one aspect, at 1104, the apparatus (e.g., a display processor) may store, in a cache and based on the second indication, the first frame. For example, FIG. 7 at 714 shows that the display processor 704 may store, in a cache and based on the second indication, the first frame. In an example, the cache may be or include the CWB buffer 410. In another example, the cache may be or include the cached CWB buffer 602. In an example, 1104 may be performed by the static region pixel reuser 199.

In one aspect, at 1114, the apparatus (e.g., a display processor) may output the post-processed blended second region for each frame in the set of frames for display on a display panel. For example, FIG. 7 at 728 shows that the display processor 704 may output the post-processed blended second region for each frame in the set of frames for display on a display panel. In an example, the aforementioned aspect may correspond to the first frame 606 and/or the second frame 612. In an example, the display panel may be or include the display(s) 131. In an example, 1114 may be performed by the static region pixel reuser 199.

In one aspect, performing the post-processing on the blended second region for each frame in the set of frames may include at least one of: adjusting a brightness of pixels of the second region for each frame in the set of frames; tone mapping the pixels of the second region for each frame in the set of frames; gamma correcting the pixels of the second region for each frame in the set of frames; or performing picture adjusting with respect to the pixels of the second region for each frame in the set of frames. For example, performing the post-processing on the blended second region for each frame in the set of frames at 726 may include at least one of: adjusting a brightness of pixels of the second region for each frame in the set of frames; tone mapping the pixels of the second region for each frame in the set of frames; gamma correcting the pixels of the second region for each frame in the set of frames; or performing picture adjusting with respect to the pixels of the second region for each frame in the set of frames.

In one aspect, obtaining the first indication of the aggregated second region in the set of frames may include receiving the first indication of the aggregated second region in the set of frames from a central processing unit (CPU). For example, FIG. 7 shows that the display processor 127 may receive the first indication of the aggregated second region in the set of frames from the CPU 702.

In one aspect, at 1108, the apparatus (e.g., a display processor) may receive a second indication to (1) blend the second region for each frame in the set of frames and (2) perform the post-processing on the second region for each frame in the set of frames, where blending the second region and performing the post-processing on the second region may be based on the second indication. For example, FIG. 7 at 722 shows that the display processor 704 may receive a second indication to (1) blend the second region for each frame in the set of frames and (2) perform the post-processing on the second region for each frame in the set of frames, where blending the second region and performing the post-processing on the second region may be based on the second indication. In an example, 1108 may be performed by the static region pixel reuser 199.

In configurations, a method or an apparatus for display processing is provided. The apparatus may be a GPU, a CPU, or some other processor that may perform display processing. In aspects, the apparatus may be the processing unit 120 within the device 104, or may be some other hardware within the device 104 or another device. The apparatus (e.g., the processing unit 120) may include means for obtaining a first indication that a first region of a first frame will remain static. The apparatus (e.g., the processing unit 120) may further include means for aggregating, based on the first indication, a second region for each frame in a set of frames that is subsequent to the first frame, where each frame in the set of frames includes the first region that will remain static, and where the second region for each frame in the set of frames differs for each frame in the set of frames. The apparatus (e.g., the processing unit 120) may further include means for outputting a second indication of the aggregated second region for each frame in the set of frames. The apparatus (e.g., the processing unit 120) may further include means for transmitting, based on the first indication, a third indication to store the first frame, where the first frame is post-processed. The apparatus (e.g., the processing unit 120) may further include means for determining a usage pattern of an application associated with the first frame based on usage data for the application, where the first indication is obtained based on the usage pattern. The apparatus (e.g., the processing unit 120) may further include means for providing, as input to the machine learning model, data indicative of user input with respective to the application, where obtaining the first indication includes obtaining the first indication as output from the machine learning model, and where the first indication is obtained based on the data indicative of the user input with respect to the application and the set of learned parameters. The apparatus (e.g., the processing unit 120) may further include means for obtaining a third indication that values of first pixels of the first region of the first frame are within a threshold range of blended second pixels of the second region for each frame in the set of frames. The apparatus (e.g., the processing unit 120) may further include means for monitoring, based on the third indication, for a fourth indication that a third region of a third frame will remain static, where the third frame is subsequent to the first frame and the set of frames. The apparatus (e.g., the processing unit 120) may further include means for receiving, subsequent to the monitoring, the fourth indication that the third region of the third frame will remain static. The apparatus (e.g., the processing unit 120) may further include means for configuring display hardware to (1) blend the second region for each frame in the set of frames and (2) perform post-processing on the second region for each frame in the set of frames.

In configurations, a method or an apparatus for display processing is provided. The apparatus may be a DPU, a display processor, or some other processor that may perform display processing. In aspects, the apparatus may be the display processor 127 within the device 104, or may be some other hardware within the device 104 or another device. The apparatus (e.g., the display processor 127) may include means for obtaining a first indication of an aggregated second region for each frame in a set of frames, where each frame in the set of frames includes a first region that will remain static, where the second region for each frame in the set of frames differs for each frame in the set of frames, and where the set of frames is subsequent to a first frame that includes the first region. The apparatus (e.g., the display processor 127) may further include means for blending, based on the first frame, the second region for each frame in the set of frames. The apparatus (e.g., the display processor 127) may include means for performing post-processing on the blended second region for each frame in the set of frames. The apparatus (e.g., the display processor 127) may include means for receiving, prior to the obtainment of the first indication, a second indication to store the first frame, where the first frame is post-processed. The apparatus (e.g., the display processor 127) may include means for storing, in a cache and based on the second indication, the first frame. The apparatus (e.g., the display processor 127) may include means for outputting the post-processed blended second region for each frame in the set of frames for display on a display panel. The apparatus (e.g., the display processor 127) may include means for receiving a second indication to (1) blend the second region for each frame in the set of frames and (2) perform the post-processing on the second region for each frame in the set of frames, where blending the second region and performing the post-processing on the second region are based on the second indication.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.
Aspect 1 is a method of display processing, comprising: obtaining a first indication that a first region of a first frame will remain static; aggregating, based on the first indication, a second region for each frame in a set of frames that is subsequent to the first frame, wherein each frame in the set of frames includes the first region that will remain static, and wherein the second region for each frame in the set of frames differs for each frame in the set of frames; and outputting a second indication of the aggregated second region for each frame in the set of frames.
Aspect 2 may be combined with aspect 1 and further comprises transmitting, based on the first indication, a third indication to store the first frame, wherein the first frame is post-processed.
Aspect 3 may be combined with any of aspects 1-2 and further comprises determining a usage pattern of an application associated with the first frame based on usage data for the application, wherein the first indication is obtained based on the usage pattern.
Aspect 4 may be combined with aspect 3 and comprises that determining the usage pattern includes training or updating a machine learning model based on the usage data, wherein the machine learning model includes a set of learned parameters that are based on the usage data.
Aspect 5 may be combined with aspect 4 and further comprises providing, as input to the machine learning model, data indicative of user input with respective to the application, wherein obtaining the first indication includes obtaining the first indication as output from the machine learning model, and wherein the first indication is obtained based on the data indicative of the user input with respect to the application and the set of learned parameters.
Aspect 6 may be combined with any of aspects 1-5 and comprises that outputting the second indication of the aggregated second region for each frame in the set of frames includes outputting the second indication of the aggregated second region for each frame in the set of frames to a display processing unit (DPU).
Aspect 7 may be combined with any of aspects 1-6 and further comprises obtaining a third indication that values of first pixels of the first region of the first frame are within a threshold range of blended second pixels of the second region for each frame in the set of frames; and monitoring, based on the third indication, for a fourth indication that a third region of a third frame will remain static, wherein the third frame is subsequent to the first frame and the set of frames.
Aspect 8 may be combined with aspect 7 and further comprises receiving, subsequent to the monitoring, the fourth indication that the third region of the third frame will remain static.
Aspect 9 may be combined with any of aspects 1-8 and further comprises configuring display hardware to (1) blend the second region for each frame in the set of frames and (2) perform post-processing on the second region for each frame in the set of frames.
Aspect 10 may be combined with aspect 9 and comprises that configuring the display hardware includes: transmitting, to the display hardware, a third indication to (1) blend the second region for each frame in the set of frames and (2) perform the post-processing on the second region for each frame in the set of frames.
Aspect 11 is an apparatus for display processing including a processor coupled to a memory and configured to implement a method as in any of aspects 1-10.
Aspect 12 may be combined with aspect 11 and includes that the apparatus is a wireless communication device comprising at least one of a transceiver or an antenna coupled to the processor, where the processor is configured to obtain the first frame via at least one of the transceiver or the antenna.
Aspect 13 is an apparatus for display processing including means for implementing a method as in any of aspects 1-10.
Aspect 14 is a computer-readable medium storing computer executable code, the computer executable code, when executed by a processor, causes the processor to implement a method as in any of aspects 1-10.
Aspect 15 is a method of display processing, comprising: obtaining a first indication of an aggregated second region for each frame in a set of frames, wherein each frame in the set of frames includes a first region that will remain static, wherein the second region for each frame in the set of frames differs for each frame in the set of frames, and wherein the set of frames is subsequent to a first frame that includes the first region; blending, based on the first frame, the second region for each frame in the set of frames; and performing post-processing on the blended second region for each frame in the set of frames.
Aspect 16 may be combined with aspect 15 and comprises that the post-processing is not performed on the first region.
Aspect 17 may be combined with any of aspects 15-16 and further comprises receiving, prior to the obtainment of the first indication, a second indication to store the first frame, wherein the first frame is post-processed; and storing, in a cache and based on the second indication, the first frame.
Aspect 18 may be combined with any of aspects 15-17 and further comprises outputting the post-processed blended second region for each frame in the set of frames for display on a display panel.
Aspect 19 may be combined with any of aspects 15-18 and comprises that performing the post-processing on the blended second region for each frame in the set of frames includes at least one of: adjusting a brightness of pixels of the second region for each frame in the set of frames; tone mapping the pixels of the second region for each frame in the set of frames; gamma correcting the pixels of the second region for each frame in the set of frames; or performing picture adjusting with respect to the pixels of the second region for each frame in the set of frames.
Aspect 20 may be combined with any of aspects 15-19 and comprises that obtaining the first indication of the aggregated second region in the set of frames includes receiving the first indication of the aggregated second region in the set of frames from a central processing unit (CPU).
Aspect 21 may be combined with any of aspects 15-20 and further comprises receiving a second indication to (1) blend the second region for each frame in the set of frames and (2) perform the post-processing on the second region for each frame in the set of frames, wherein blending the second region and performing the post-processing on the second region are based on the second indication.
Aspect 22 is an apparatus for display processing including a processor coupled to a memory and configured to implement a method as in any of aspects 15-21.
Aspect 23 may be combined with aspect 22 and includes that the apparatus is a wireless communication device comprising at least one of a transceiver or an antenna coupled to the processor, where the processor is configured to obtain the set of frames via at least one of the transceiver or the antenna.
Aspect 24 is an apparatus for display processing including means for implementing a method as in any of aspects 15-21.
Aspect 25 is a computer-readable medium (e.g., a non-transitory computer-readable medium) storing computer executable code, the computer executable code, when executed by a processor, causes the processor to implement a method as in any of aspects 15-21.

Various aspects have been described herein. These and other aspects are within the scope of the following claims.

1. An apparatus for display processing, comprising:
a memory; and
a processor coupled to the memory and, based on information stored in the memory, the processor is configured to:
obtain a first indication that a first region of a first frame will remain static;
aggregate, based on the first indication, a second region for each frame in a set of frames that is subsequent to the first frame, wherein each frame in the set of frames includes the first region that will remain static, and wherein the second region for each frame in the set of frames differs for each frame in the set of frames; and
output a second indication of the aggregated second region for each frame in the set of frames.

2. The apparatus of claim 1, wherein the processor is further configured to:
transmit, based on the first indication, a third indication to store the first frame, wherein the first frame is post-processed.

3. The apparatus of claim 1, wherein the processor is further configured to:
determine a usage pattern of an application associated with the first frame based on usage data for the application, wherein to obtain the first indication, the processor is configured to obtain the first indication based on the usage data.

4. The apparatus of claim 3, wherein to determine the usage pattern, the processor is configured to train or update a machine learning model based on the usage data, wherein the machine learning model includes a set of learned parameters that are based on the usage data.

5. The apparatus of claim 4, wherein the processor is further configured to:
provide, as input to the machine learning model, data indicative of user input with respective to the application, wherein to obtain the first indication, the processor is configured to obtain the first indication as output from the machine learning model, and wherein the first indication is based on the data indicative of the user input with respect to the application and the set of learned parameters.

6. The apparatus of claim 1, wherein to output the second indication of the aggregated second region for each frame in the set of frames, the processor is configured to output the second indication of the aggregated second region for each frame in the set of frames to a display processing unit (DPU).

7. The apparatus of claim 1, wherein the processor is further configured to:
obtain a third indication that values of first pixels of the first region of the first frame are within a threshold range of blended second pixels of the second region for each frame in the set of frames; and
monitor, based on the third indication, for a fourth indication that a third region of a third frame will remain static, wherein the third frame is subsequent to the first frame and the set of frames.

8. The apparatus of claim 7, wherein the processor is further configured to:
receive, subsequent to the monitoring, the fourth indication that the third region of the third frame will remain static.

9. The apparatus of claim 1, wherein the processor is further configured to:
configure display hardware to (1) blend the second region for each frame in the set of frames and (2) perform post-processing on the second region for each frame in the set of frames.

10. The apparatus of claim 9, wherein to configure the display hardware, the processor is configured to transmit, to the display hardware, a third indication to (1) blend the second region for each frame in the set of frames and (2) perform the post-processing on the second region for each frame in the set of frames.

11. The apparatus of claim 1, wherein the apparatus is a wireless communication device comprising at least one of a transceiver or an antenna coupled to the processor, and wherein to obtain the first indication, the processor is configured to obtain the first indication via at least one of the transceiver or the antenna.

12. An apparatus for display processing, comprising:
a memory; and
a processor coupled to the memory and, based on information stored in the memory, the processor is configured to:
obtain a first indication of an aggregated second region for each frame in a set of frames, wherein each frame in the set of frames includes a first region that will remain static, wherein the second region for each frame in the set of frames differs for each frame in the set of frames, and wherein the set of frames is subsequent to a first frame that includes the first region;
blend, based on the first frame, the second region for each frame in the set of frames; and
perform post-processing on the blended second region for each frame in the set of frames.

13. The apparatus of claim 12, wherein the post-processing is not performed on the first region.

14. The apparatus of claim 12, wherein the processor is further configured to:
receive, prior to the obtainment of the first indication, a second indication to store the first frame, wherein the first frame is post-processed; and
store, in a cache and based on the second indication, the first frame.

15. The apparatus of claim 12, wherein the processor is further configured to:
output the post-processed blended second region for each frame in the set of frames for display on a display panel.

16. The apparatus of claim 12, wherein to perform the post-processing on the blended second region for each frame in the set of frames, the processor is configured to perform at least one of:
an adjustment of a brightness of pixels of the second region for each frame in the set of frames;
a tone mapping of the pixels of the second region for each frame in the set of frames;
a gamma correction of the pixels of the second region for each frame in the set of frames; or
a picture adjustment with respect to the pixels of the second region for each frame in the set of frames.

17. The apparatus of claim 12, wherein to obtain the first indication of the aggregated second region in the set of frames, the processor is configured to receive the first indication of the aggregated second region in the set of frames from a central processing unit (CPU).

18. The apparatus of claim 12, wherein the processor is further configured to:
receive a second indication to (1) blend the second region for each frame in the set of frames and (2) perform the post-processing on the second region for each frame in the set of frames, wherein to blend the second region, the processor is configured to blend the second region based on the second indication, and wherein to perform the post-processing on the second region, the processor is configured to perform the post-processing based on the second indication.

19. The apparatus of claim 12, wherein the apparatus is a wireless communication device comprising at least one of a transceiver or an antenna coupled to the processor, and wherein to obtain the first indication, the processor is configured to obtain the first indication via at least one of the transceiver or the antenna.

20. A method of display processing, comprising:
obtaining a first indication that a first region of a first frame will remain static;
aggregating, based on the first indication, a second region for each frame in a set of frames that is subsequent to the first frame, wherein each frame in the set of frames includes the first region that will remain static, and wherein the second region for each frame in the set of frames differs for each frame in the set of frames; and
outputting a second indication of the aggregated second region for each frame in the set of frames.

21.-30 (canceled)
